(19) United States
(12) Patent Application Publication
(10) Pub. No.: US 2007/0292655 A1
(43) Pub. Date: Dec. 20, 2007

(54) TUFT COATING

(75) Inventor: Donald C. Albin, Carlisle, PA (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: Lear Corporation, Southfield, MI (US)

(21) Appl. No.: 11/424,985

(22) Filed: Jun. 19, 2006

(51) Int. Cl. D05C 17/02; B32B 33/00; B32B 3/02

(52) U.S. Cl. 428/92; 428/95; 156/72

(57) ABSTRACT

A tufted carpet includes a primary backing and a plurality of tufts. The plurality of tufts are attached to the primary backing by looping each yarn tuft through different openings of the primary backing with strand sections from adjacent tufts going through each opening. The tufted carpet further includes an adhesive or polymeric material contacting the tufts such that the tufts are bonded together. A system and method for forming the tufted carpets is also provided.

### BACKGROUND OF THE INVENTION

1. Field of the Invention

This invention relates generally to tufted carpets simultaneously having abrasion resistance and enhanced tuft bind performance.

2. Background Art

The vast majority of carpets currently used in commercial and non-commercial applications are either non-woven carpets or tufted carpets. Tufted carpets are often considered to be higher quality. Tufted carpets typically include a latex backing which is applied uniformly over the entire back of the carpet. These carpets are fabricated by taking a primary backing that is a fabric (e.g, spun bond polyester) into which a yarn can be punched. After the yarn is punched into the primary backing, the tops of the pile of yarn protruding from the top side of the carpet are cut to form cut pile carpets. When the back of the carpet is viewed, the yarn tufts and the primary backing are visible. In conventional application of latex, a pool of latex is dropped onto the back of the carpet. The carpet is then run under a device (e.g., a nip roller) in order to push the latex into the tuft and the primary backing. The carpet is then dried with the tufts adhered to the carpet. Specifically, the latex contacts both the tufts and the primary backing such that the yarn is adhered to the carpet. This makes the carpet durable by preventing the yarn from being pulled out during normal use. The usual prior art methods use significant amounts of latex in which both the primary backing and yarn tufts are coated. Similarly, in loop pile carpets such as berber carpets, the tufts are not cut off.

The durability of carpet is typically evaluated by two test methods. The first test method is abrasion resistance tested according to SAE J1530. In abrasion resistance determination, a sanding wheel is run across the carpet for a sufficient number of cycles until failure of the carpet is reached. In this method, the carpet is rotated while contacting the abrasive wheel, causing the wheel to turn. During this test, the yarn is worn down until the face side is visually unacceptable (i.e., failure). Typically, failure occurs when visual inspection of the face side reveals an unacceptable amount of exposed backing. The number of cycles to reach this failure point is recorded as the result of the test. The second method evaluates tuft bind in accordance with ASTM-D1335. In the tuft bind method, a tow of yarn is grasped with tweezers and pulled at a constant rate of expansion. The maximum force necessary to pull the yarn out of the backing is measured. These two test methods differ significantly and may produce divergent analysis. For example, for many carpets, it is observed that when the abrasion resistance goes up, the tuft bind goes down. Therefore, the tighter the toes are held to the backing, the worse the abrasion resistance becomes possibly due to the inability of the yarn to move slightly in response to abrasive loads. Moreover, thinner carpets are becoming more desirable for automotive application, making the simultaneous realization of abrasion resistance and tuft bind even harder.

Accordingly, there exists a need for improved tufted carpets having high abrasion resistance and tuft bind performance.

### SUMMARY OF THE INVENTION

The present invention solves one or more problems of the prior art by providing a tufted carpet with a non-uniform polymeric backing. The tufted carpet of the present invention is useful in any application in which tufted carpets are typically used, and in particular, in any automotive application where such carpets are used. Examples include, but are not limited to, floors, trim panels, seat backs, trunks, package trays, throw-in matts, and the like. The tufted carpet of the present invention includes a primary backing and a plurality of tufts. The plurality of tufts is attached to the primary backing by looping of each yarn tuft through different openings of the primary backing with strand sections from adjacent tufts going through each opening. The tufted carpet of the present embodiment has an adhesive or polymeric material contacting the tufts such that the tufts are bonded together. Advantageously, little or no polymer contacts the primary backing, thereby allowing the yarn to move relative to the primary backing and simultaneously providing improved abrasion resistance and tuft bind performance.

In another embodiment of the present invention, a tufting system for forming the tufted carpet set forth above is provided. The tufting system of this embodiment includes a tufting needle which moves in a direction such that a flexible strand is punched through a primary backing. The tufting system further includes an adhesive or polymeric material applicator nozzle that is used to apply adhesive or polymeric material to the tufts from the back side.

In yet another embodiment of the present invention, a method for making the tufted carpet of the present invention is provided. The method of this embodiment comprises forming a plurality of tufts by punching a flexible strand through the primary backing. Next, an adhesive or polymeric material is applied to the plurality of tufts at a position such that the adhesive or polymeric material contacts adjacent tufts at the position proximate to the openings and the back side of the primary backing.

### BRIEF DESCRIPTION OF THE DRAWINGS

FIG. 1 is a schematic illustration of an embodiment of a tufted carpet of the present invention;

FIG. 2A is a top-view schematic illustration of a linear bead formed across the width of the tufted carpet;

FIG. 2B is a top-view schematic illustration of adhesive or polymeric material spatially localized in the vicinity of the position at which adjacent strands are proximate;

FIG. 3 is a schematic illustration of a system for forming the tufted carpet of the invention;

FIG. 4A provides a perspective view of a variation of an adhesive or polymeric material applicator nozzle useable to apply adhesive or polymeric material to the tufts of the present invention via a slot;

FIG. 4B is a perspective view of a variation of an adhesive or polymeric material applicator nozzle used to apply adhesive or polymeric material to the tufts of the present invention via a plurality of orifices;

FIG. 5 is a schematic illustration of a variation of an adhesive or polymeric material applicator nozzle using air to spray the adhesive or polymeric material;

FIG. 6 is a schematic illustration of a variation of the tufting system described in connection with FIG. 3;

FIG. 7 is a schematic illustration of another variation of the system described in connection with the system of FIG. 3; and

FIG. 8 is a schematic illustration of a variation of the application of adhesive or polymeric material to the tufts used in various embodiments of the invention.

### DETAILED DESCRIPTION OF THE INVENTION

Reference will now be made in detail to presently preferred compositions or embodiments and methods of the invention, which constitute the best modes of practicing the invention presently known to the inventors.

The term “tuft” as used herein means projections of yarns drawn through a fabric or making up a fabric so as to produce a surface of raised loops or cut pile.

The term “cut pile” as used herein refers to a type of carpet in which the yarn loops are cut to create a textured look and feel.

The term “yarn” as used herein refers to a bundle of fibers that is twisted together to form a continuous strand.

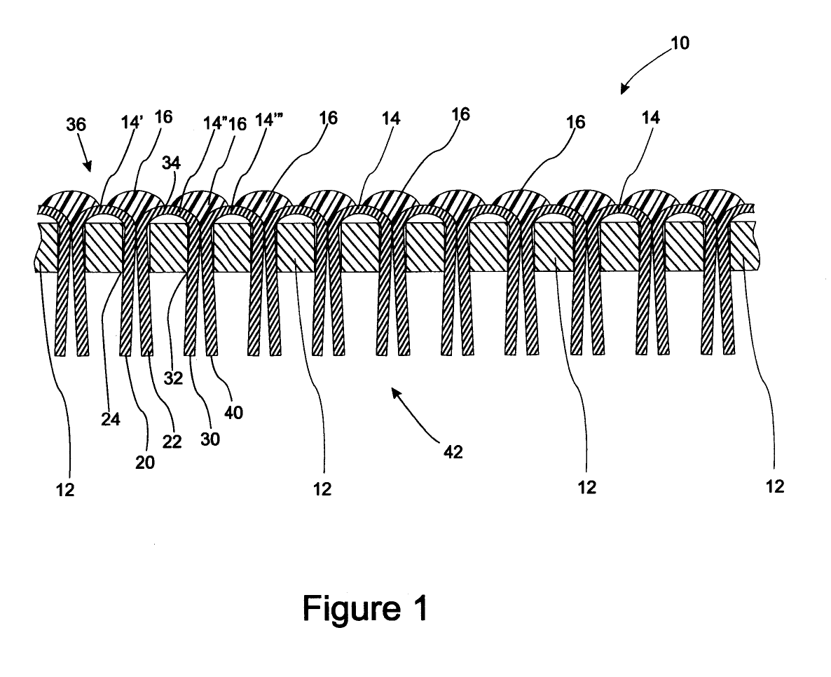

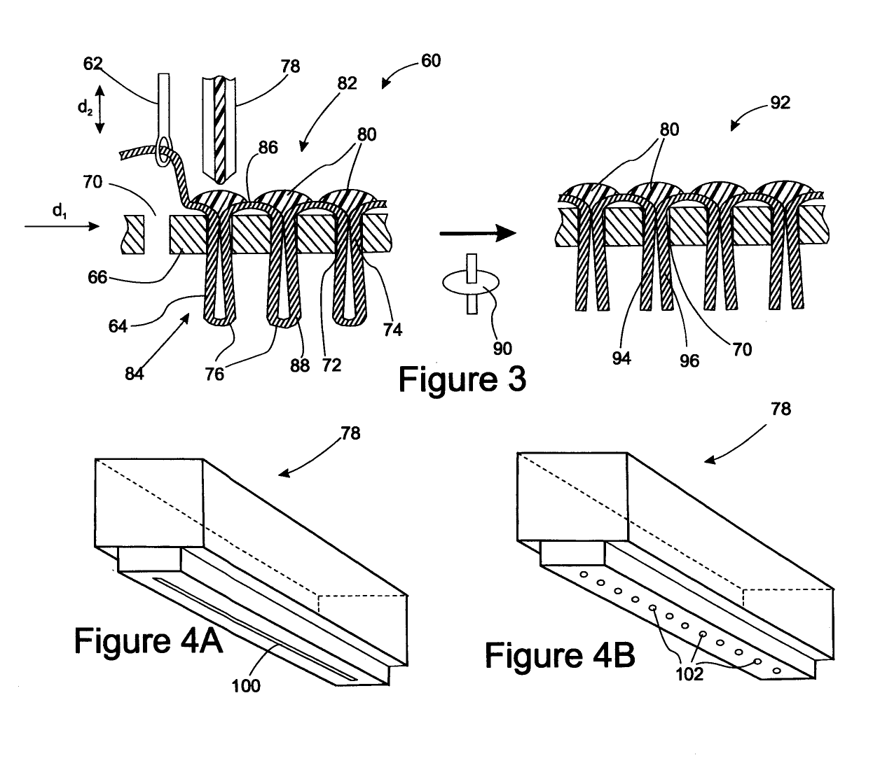

With reference to FIG. 1, a schematic illustration of an embodiment of a tufted carpet of the present invention is provided. Tufted carpet 10 includes primary backing 12 to which a plurality of tufts 14 are attached. The plurality of tufts 14 comprise a plurality of flexible strand sections. In a variation of the invention, a plurality of tufts 14 is formed from a yarn. Examples of suitable material from which the yarns are formed include, but are not limited to, nylon yarns, polypropylene yarns, polyester yarns, and the like. In a variation of the primary embodiment, primary backing 12 is a fabric or textile. Examples of materials from which primary backing 12 is formed include, but are not limited to, polyester, polypropylene, nylon, and combinations thereof. Adhesive or polymeric material 16 attaches adjacent tufts together. Adhesive or polymeric material 16 comprises any material that is capable of adhering adjacent tufts together. Examples of such materials include but are not limited to, latex. FIG. 1 illustrates a variation of the carpet in which the piles are cut thereby forming a cut pile carpet. In another variation of the invention, the piles are not cut (see FIG. 3 below).

Still referring to FIG. 1, each of a plurality of flexible strands are attached to primary backing 12 by passing each end of a given strand through different openings in primary backing 12. For example, consider adjacent strands 14′, 14″, and 14′″. Strand section 20 of yarn 14′ and strand section 22 of strand 14″ pass through opening 24 in primary backing 12. Strand 14′ is attached to adjacent strand 14″ by adhesive or polymeric material 16′. Strand section 30 of strand 14″ passes through adjacent opening 32, forming strand loop 34 positioned on back side 36 of tuft carpet 10. Loop 34 is a base for the tufts with ends edge emanating therefrom. Similarly, strand section 40 of strand 14′″also passes through opening 32. Strand 14″ is attached to adjacent strand 14′″ by adhesive or polymeric material 16″. This pattern of attaching adjacent strands with one end from each adjacent strand passing through the same opening in primary backing 12 and being attached to each other with an adhesive or polymeric material is repeated throughout tufted carpet 10. Accordingly, the ends of strands 14 are visible from face side 42 of tufted carpet 10.

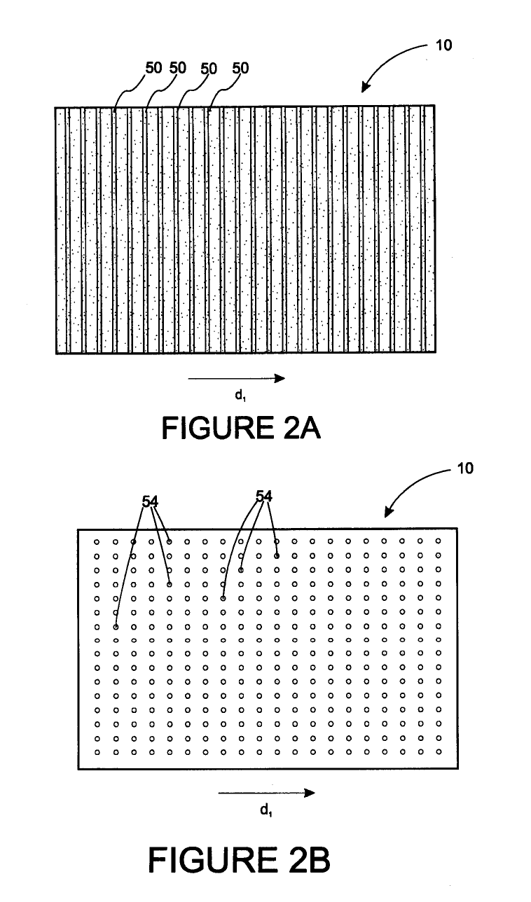

With reference to FIGS. 2A and 2B, variations of the attachment of adjacent strands together in accordance with the present invention are provided. FIG. 2A provides a top schematic illustration of a linear bead of adhesive or polymeric material formed across the width of the tufted carpet. In this variation, adhesive or polymeric material that attaches adjacent strands together is formed into rows 50 that are substantially perpendicular to machine direction d₁. Machine direction d₁, is the direction that tufted carpet 10 transverses during the tufting process. In this variation, the rows of adhesive or polymeric material contact primary backing 12 between successive rows of tufts. FIG. 2B provides a top schematic illustration of adhesive or polymeric material 54, spatially localized in the vicinity of the position at which adjacent strands are proximate. In this variation, there is minimal contact of the adhesive or polymeric material to primary backing 12. In another variation of the of the invention, linear beads of adhesive or polymeric material are applied to form rows substantially parallel to the machine direction.

With reference to FIG. 3, a schematic illustration of a system for forming the tufted carpet set forth above is provided. Tufting systems 60 includes tufting needle 62, which moves substantially along direction d₂ as flexible strand 64 is punched through primary backing 66. During tufting, primary backing 66 moves along machine direction d₁. After being punched through primary backing 66, flexible strand 64 passes through openings 70 in primary backing 66 which two strands section 72, 74 pass through each of the openings 70 to form tufts 76. Adhesive or polymeric material applicator nozzle 78 is used to apply adhesive or polymeric material 80 on back side 82 at a position in the vicinity of openings 70 from which strand section emanate from back side 82 to face side 84. Strand loop 86 is located on back side 82 between adjacent openings 70 while strand loops 88 are located on the face side of the carpet. If tufts 76 are not cut, the resulting carpet is a loop pile carpet. In a variation of the present embodiment, tufting system 60 includes tuft cutter 90 which cuts the tops off of tufts 76 to form cut pile tufted carpet 92. Tufted carpet 92 includes a plurality of strand sections 94, 96 (with the tops cut off) passing through openings 70. The details of the composition of primary packing 66, flexible strand 64, and adhesive or polymeric material 80 are the same as that set forth above in connection with the description of FIG. 1.

With reference to FIGS. 4A and FIG. 4B, variations for adhesive or polymeric material applicator nozzle 78 are schematically illustrated. FIG. 4A provides a perspective view of a variation of adhesive or polymeric material applicator nozzle 78 in which adhesive or polymeric material passes through slot 100 while being applied to tufts 76. In a further refinement of this variation, the application of adhesive or polymeric material is pulsed so that material is applied when the adjacent strand sections are under application nozzle 78 to produce a distribution of material as illustrated in FIG. 2A. FIG. 4B provides a perspective view of a variation of adhesive or polymeric material applicator nozzle 78 in which adhesive or polymeric material passes through orifices 102 while being applied to the tufts 76. In a further refinement of this variation, the application of adhesive or polymeric material is pulsed so that material is applied when the adjacent strand section is under application nozzle 78 to produce a distribution of material as illustrated in FIG. 2B.

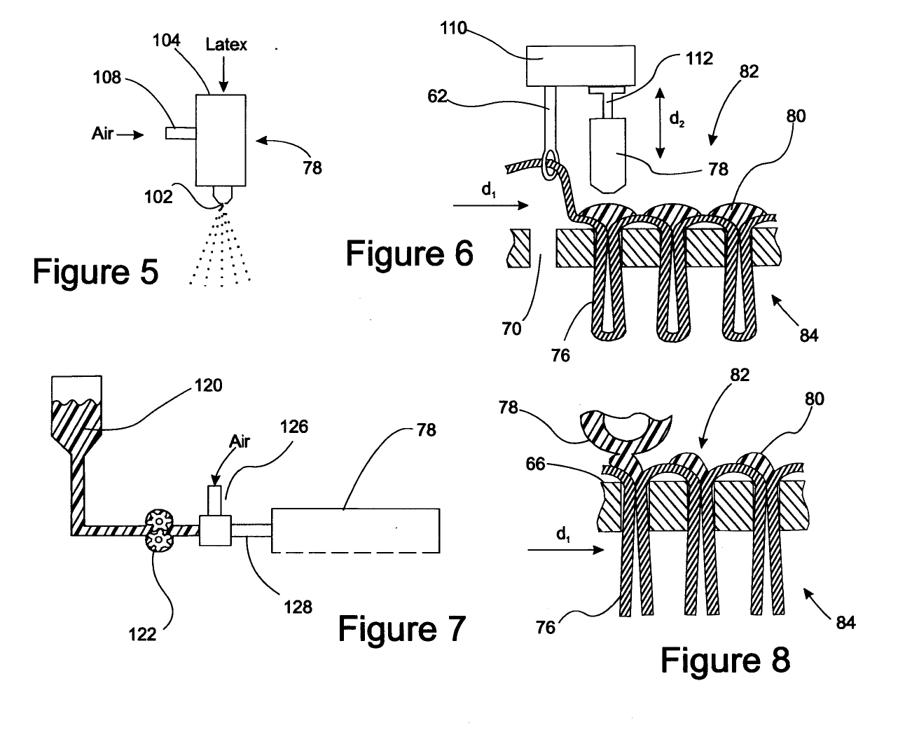

With reference to FIG. 5, a schematic illustration of another variation of adhesive or polymeric material applicator nozzle 78 is provided. In this variation, adhesive or polymeric material is sprayed or expelled onto the carpet using orifice(s) 102. In this variation, adhesive or polymeric material enters the nozzle 78 through inlet port 104. Expulsion of the adhesive or polymeric material is gas assisted with a gas such as air or nitrogen being introduced into the inlet port 108.

With reference to FIG. 6, a variation of the tufting system described in connection with FIG. 3 is provided. In this variation, the motion of tufting needle 62 along direction d₂ is utilized to apply adhesive or polymeric material to the carpet. Pusher section 110 moves in unison with needle 62 contacting piston 112 so that adhesive or polymeric material is pushed out of nozzle 78 and applied to the carpet.

With reference to FIG. 7, a schematic illustration of a variation of the system described in connection with the system of FIG. 3 is provided. In this variation, the adhesive material is provided from reservoir 120 to nozzle 78 via fluid control device 122. Such flow control devices include, but are not limited to, gear pumps, mass flow controllers, and the like. Optionally, gas is used to assist the application of adhesive or polymeric material to tufts 76. Such gas is introduced via gas inlet 126. The gas/material combination enters nozzle 78 via inlet port 128.

With reference to FIG. 8, a schematic illustration of the application of adhesive or polymeric material to tufts 76 is provided. FIG. 7 provides a cross-section view substantially parallel to the tufting machine direction d₁. In this variation, nozzle 78 applies adhesive or polymeric material 80 in a wedge-like manner to tufts 76 building up on one side of tufts 78.

In yet another embodiment of the present invention, a method for making the tufted carpet of the present invention is provided. The method of this embodiment comprises forming a plurality of tufts by punching a flexible strand through the primary backing. Next, an adhesive or polymeric material is applied to the plurality of tufts at a position such that the adhesive or polymeric material contact adjacent tufts at the position proximate to the openings and the back side of the primary backing. In variations of the present invention, the systems described in connection with FIGS. 3-8 are advantageously utilized.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tufted carpet having a back side and a face side, the tufted carpet comprising:
a primary backing having a plurality of openings;
a plurality of tufts attached to the primary backing, the plurality of tufts comprising a plurality of strand sections such that two strand sections from the plurality of tufts protrude through an opening of the plurality of openings, wherein each of the two strand sections are derived from different but adjacent tufts; and
an adhesive or polymeric material contacting adjacent tufts at a position proximate to the openings and the back side of the primary backing.

2. The tufted carpet of claim 1 wherein the plurality of tufts comprise a yarn.

3. The tufted carpet of claim 2 wherein the yarn comprises a component selected from the group consisting of nylon yarns, polypropylene yarns, and polyester yarns.

4. The tufted carpet of claim 1 wherein the primary backing is a fabric or textile.

5. The tufted carpet of claim 4 wherein the primary backing comprises a material selected from the group consisting of polyester, polypropylene, nylon, and combinations thereof.

6. The tufted carpet of claim 1 wherein the adhesive or polymeric material comprises a latex.

7. The tufted carpet of claim 1 wherein the adhesive or polymeric material is disposed over the primary backing in a pattern of rows.

8. The tufted carpet of claim 7 wherein the rows are substantially perpendicular or substantially parallel to a machine direction used to form the tufted carpet.

9. The tufted carpet of claim 1 wherein the adhesive or polymeric material is spatially localized in the vicinity of adjacent tufts.

10. The tufted carpet of claim 1 wherein the adhesive or polymeric material contacts the tufts in a wedge-like manner.

11. The tufted carpet of claim 1 wherein the tufts are uncut and the tufted carpet is a loop pile carpet.

12. The tufted carpet of claim 1 wherein the tufts are cut and the tufted carpet is a cut pile carpet.

13. A system for making a tufted carpet having a back side and a face side, the tufted carpet comprising a primary backing having a plurality of openings; a plurality of tufts attached to the primary backing, the plurality of tufts comprising a plurality of strand sections such that two strand sections from the plurality of tufts protrude through an opening of the plurality of openings, wherein each of the two strand sections are derived from different but adjacent tufts; and an adhesive or polymeric material contacting adjacent tufts at a position proximate to the openings and the back side of the primary backing, the system comprising:
a tufting needle that moves in a manner such that a flexible strand is punched through the primary backing; and
an adhesive or polymeric material applicator nozzle for applying the adhesive or polymeric material.

14. The system of claim 13 wherein the adhesive or polymeric material applicator nozzle comprises a nozzle having a slit through which the adhesive or polymeric material passes.

15. The system of claim 13 wherein the adhesive or polymeric material applicator nozzle comprises one or more orifices through which the adhesive or polymeric material passes.

16. The system of claim 13 further comprising an inlet for mixing gas with the adhesive or polymeric material.

17. The system of claim 13 wherein the nozzle comprising a piston for applying the adhesive or polymeric material, and the tuft forming system further comprises a pusher in communication with the tufting need, the pusher contacting the piston during movement of the needle in a manner such that adhesive or polymeric material is applied to the tufts.

18. The system of claim 13 wherein the tufted carpet forming system further comprises a flow control device for introducing adhesive or polymeric material to the nozzle.

19. A method of forming a tufted carpet having a back side and a face side, the tufted carpet comprising a primary backing having a plurality of openings; a plurality of tufts attached to the primary backing, the plurality of tufts comprising a plurality of strand sections such that two strand sections from the plurality of tufts protrude through an opening of the plurality of openings, wherein each of the two strand sections are derived from different but adjacent tufts; and an adhesive or polymeric material contacting adjacent tufts at a position proximate to the openings and the back side of the primary backing, the method comprising:
forming the plurality of tufts by punching a flexible strand through the primary backing; and
applying the adhesive or polymeric material to the plurality of tufts at a position such that the adhesive or polymeric material contacts adjacent tufts at the position proximate to the openings and the back side of the primary backing.

20. The method of claim 19 further comprising cutting the plurality of tufts to form a cut pile carpet.
